(19) United States
(12) Patent Application Publication
(10) Pub. No.: US 2026/0030318 A1
(43) Pub. Date: Jan. 29, 2026

(54) A PROCESSING UNIT IN MEMORY FOR PERFORMING MATRIX-VECTOR MULTIPLICATION OPERATIONS

(71) Applicant: Micron Technology, Inc., Boise, ID (US)

(72) Inventors: Glen E. Hush, Boise, ID (US); Peter L. Brown, Eagle, ID (US); Xinyu Wu, Boise, ID (US); Troy D. Larsen, Meridian, ID (US); Timothy P. Finkbeiner, Boise, ID (US); Troy A. Manning, Meridian, ID (US)

(21) Appl. No.: 19/038,924

(22) Filed: Jan. 28, 2025

Related U.S. Application Data
(60) Provisional application No. 63/560,071, filed on Mar. 1, 2024.

(51) Int. Cl. G06F 17/16; G06F 7/544

(52) U.S. Cl. CPC G06F 17/16; G06F 7/5443

(57) ABSTRACT

The processing unit (PU) PU of a memory device can receive a matrix of data values and a vector of data values stored in a bank. The PU can perform a first plurality of multiplication operations on a first data value of the vector utilizing a first plurality of data values of a first column of the matrix. The first plurality of multiplication operations can be performed by a plurality of multiply-accumulate (MAC) units. Each of the first plurality of multiplication operations can be performed by a different MAC unit of the plurality of MAC units. The PU can perform a second plurality of multiplication operations on a second data value of the vector utilizing a second plurality of data values of a second column of the matrix. Each of the second plurality of multiplication operations can be performed by a different MAC unit of the plurality of MAC units.

### PRIORITY INFORMATION

This application claims the benefit of U.S. Provisional Application No. 63/560,071, filed on Mar. 1, 2024, the contents of which are incorporated herein by reference.

### TECHNICAL FIELD

The present disclosure relates generally to memory, and more particularly to apparatuses and methods associated with performing matrix-vector multiplication operations using a processing unit in memory.

### BACKGROUND

Memory devices are typically provided as internal, semiconductor, integrated circuits in computers or other electronic devices. There are many different types of memory including volatile and non-volatile memory. Volatile memory can require power to maintain its data and includes random-access memory (RAM), dynamic random access memory (DRAM), and synchronous dynamic random access memory (SDRAM), among others. Non-volatile memory can provide persistent data by retaining stored data when not powered and can include NAND flash memory, NOR flash memory, read only memory (ROM), Electrically Erasable Programmable ROM (EEPROM), Erasable Programmable ROM (EPROM), and resistance variable memory such as phase change random access memory (PCRAM), resistive random access memory (RRAM), and magnetoresistive random access memory (MRAM), among others.

Memory is also utilized as volatile and non-volatile data storage for a wide range of electronic applications. Non-volatile memory may be used in, for example, personal computers, portable memory sticks, digital cameras, cellular telephones, portable music players such as MP3 players, movie players, and other electronic devices. Memory cells can be arranged into arrays, with the arrays being used in memory devices.

### BRIEF DESCRIPTION OF THE DRAWINGS

FIG. 1 is a block diagram of an apparatus in the form of a computing system including a memory device in accordance with a number of embodiments of the present disclosure.

FIG. 2 is a block diagram of a processing unit in accordance with a number of embodiments of the present disclosure.

FIG. 3 is a block diagram of a bank of memory cells and a processing unit in accordance with a number of embodiments of the present disclosure.

FIG. 4 is a block diagram of a plurality of banks of memory cells and a processing unit in accordance with a number of embodiments of the present disclosure.

FIG. 5 illustrates an example flow diagram of a method for performing a matrix-vector multiplication operation using a processing unit in memory in accordance with a number of embodiments of the present disclosure.

FIG. 6 illustrates an example machine of a computer system within which a set of instructions, for causing the machine to perform any one or more of the methodologies discussed herein, can be executed.

### DETAILED DESCRIPTION

The present disclosure includes apparatuses and methods related to performing matrix-vector multiplication operations using a processing unit in memory. A processing unit can receive a matrix of data values stored in a bank of memory cells of the memory device. The processing unit can receive a vector of data values stored in the bank. The processing unit can perform a first plurality of multiplication operations on a first data value of the vector utilizing a first plurality of data values of a first column of the matrix. The first plurality of multiplication operations can be performed by a plurality of multiply-accumulate (MAC) units. Each of the first plurality of multiplication operations can be performed by a different MAC unit of the plurality of MAC units. The processing unit can perform a second plurality of multiplication operations on a second data value of the vector utilizing a second plurality of data values of a second column of the matrix. Each of the second plurality of multiplication operations can be performed by a different MAC unit of the plurality of MAC units.

In previous memory approaches, a multiplication operation on a matrix and a vector may be performed by multiplying each row of the matrix with the vector. For example, a first data value of a first row of a matrix may be multiplied with a first data value of the vector and a second data value of the first row of the matrix may be multiplied with a second data value of the vector, etc. until each of the data values of the first row of the matrix is multiplied with a different data value of the vector. Each result of a multiplication operation performed on a data value of a row of a matrix with a data value of the vector can be accumulated to generate a result vector. For example, the result of the multiplication operation performed on a first data value of the first row of a matrix utilizing the first data value of the vector can be accumulated with a result of a multiplication operation performed on a second data value of the first row of the matrix utilizing a second data value of the vector. The accumulated result can represent a first data value of the result vector.

However, in such an approach, each data value of the result vector needs to be temporarily stored while the accumulator circuitry generates the different result values. The temporary storage can increase the cost of manufacturing memory, may increase the size of the die of the memory, and/or may delay the output of the result vector. The output may be delayed because additional operations need to be performed to combine different data values to generate the result vector.

As used herein, a matrix is a grouping of data values organized into rows and columns where each data value has an order in a row and a column. For example, a first data value of a matrix can be a first data value in a first row and a first data value in a first column. A vector is a plurality of data values organized into a single column.

In order to address these and other deficiencies of previous approaches, embodiments of the present disclosure allow for data values of columns of a matrix to be multiplied with data values of a vector to perform a matrix-vector multiplication operation. Each of the data values of a single column can be multiplied with a single data value of a vector utilizing a plurality of multiply-accumulate (MAC) units. For example, each of the data values of a first matrix column can be multiplied with a same data value of a vector using a different MAC unit. A first MAC unit can be used to multiply a first data value of a first matrix column with a first data value of a vector and to accumulate the result. The second MAC unit can also multiply a second data value of the first matrix column with the first data value of the vector. The first MAC unit can also be used to multiply a first data value of a second matrix column with a second data value of the vector and accumulate the result with a previous value stored (e.g., accumulated) in the first MAC unit. The second MAC unit can multiply a second data value of the second matrix column with a second data value of the vector and accumulate the result with a previous value stored in the first MAC unit.

Multiplying data values of columns of a matrix with data values of a vector has the advantage of not needing to store temporary values outside of the MAC units to generate the result vector. Rather, the final data values of the result vector can be retained in the MAC units, which removes the need for temporary registers which in turn reduces the cost and/or size of the memory. Retaining the final data values of the result vector in the MAC units also has the advantage of allowing the result vector to be read without performing additional operations on the data values stored in the MAC units, which removes delays (e.g., reduces the amount of time) needed to read out the result vector. Removing delays used to read out the result vector allows a matrix and a vector to be multiplied in the same amount of time as it would take for a single column of a memory address (e.g., 256 prefetch) worth of the matrix and the vector to be read out of the memory. Removing delays used to read out the result vector also allows the result vector to be generated and provided to the input/output (I/O) lines using a same data path as is used to read out data from the memory arrays (e.g., banks of memory).

As used herein, “a number of” something can refer to one or more of such things. For example, a number of memory devices can refer to one or more memory devices. A “plurality” of something intends two or more. Additionally, designators such as “N,” as used herein, particularly with respect to reference numerals in the drawings, indicates that a number of the particular feature so designated can be included with a number of embodiments of the present disclosure.

The figures herein follow a numbering convention in which the first digit or digits correspond to the drawing figure number and the remaining digits identify an element or component in the drawing. Similar elements or components between different figures may be identified by the use of similar digits. As will be appreciated, elements shown in the various embodiments herein can be added, exchanged, and/or eliminated so as to provide a number of additional embodiments of the present disclosure. In addition, the proportion and the relative scale of the elements provided in the figures are intended to illustrate various embodiments of the present disclosure and are not to be used in a limiting sense.

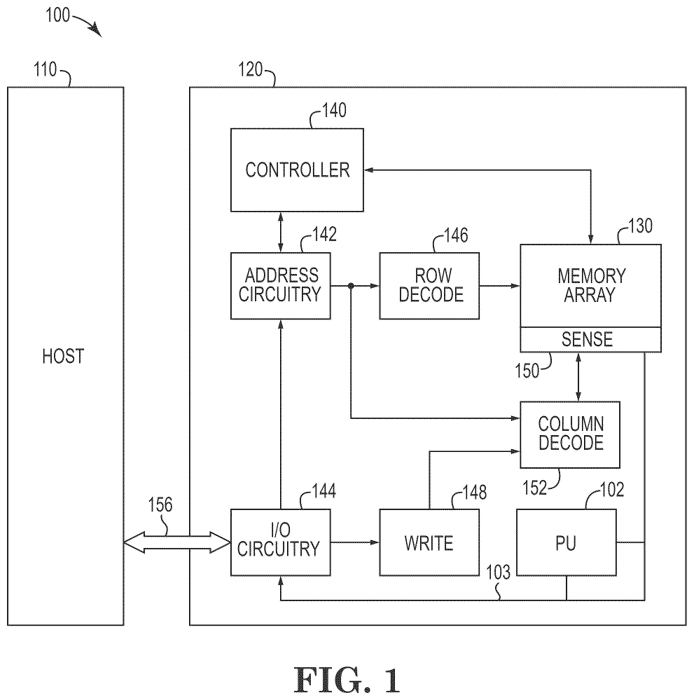

FIG. 1 is a block diagram of an apparatus in the form of a computing system 100 including a memory device 120 in accordance with a number of embodiments of the present disclosure. As used herein, a memory device 120, a memory array 130, and/or host 110 might also be separately considered an “apparatus.”

In this example, system 100 includes a host 110 coupled to memory device 120 via an interface 156. The computing system 100 can be a personal laptop computer, a desktop computer, a digital camera, a mobile telephone, a memory card reader, or an Internet-of-Things (IoT) enabled device, among various other types of systems. Host 110 can include a number of processing resources (e.g., one or more processors, microprocessors, or some other type of controlling circuitry) capable of accessing memory 120. The system 100 can include separate integrated circuits, or both the host 110 and the memory device 120 can be on the same integrated circuit. For example, the host 110 may be a system controller of a memory system comprising multiple memory devices 120, with the system controller 110 providing access to the respective memory devices 120 by another processing resource such as a central processing unit (CPU).

In the example shown in FIG. 1, the host 110 is responsible for executing an operating system (OS) and/or various applications that can be loaded thereto (e.g., from memory device 120 via controller 140). The host 110 can provide access commands and/or security mode initialization commands to a memory device via the interface 156.

For clarity, the system 100 has been simplified to focus on features with particular relevance to the present disclosure. The memory array 130 can be a DRAM array, SRAM array, STT RAM array, PCRAM array, TRAM array, RRAM array, NAND flash array, and/or NOR flash array, for instance. The array 130 can comprise memory cells arranged in rows coupled by access lines (which may be referred to herein as word lines or select lines) and columns coupled by sense lines (which may be referred to herein as digit lines or data lines). Although a single array 130 is shown in FIG. 1, embodiments are not so limited. For instance, memory device 120 may include a number of arrays 130 (e.g., a number of banks of DRAM cells).

The memory device 120 includes address circuitry 142 to latch address signals provided over an interface 156. The interface can include, for example, a physical interface employing a suitable protocol (e.g., a data bus, an address bus, and a command bus, or a combined data/address/command bus). Such protocol may be custom or proprietary, or the interface 156 may employ a standardized protocol, such as Peripheral Component Interconnect Express (PCIe), Gen-Z, CCIX, or the like. Address signals are received and decoded by a row decoder 146 and a column decoder 152 to access the memory array 130. Data can be read from memory array 130 by sensing voltage and/or current changes on the sense lines using sensing circuitry 150. The sensing circuitry 150 can comprise, for example, sense amplifiers that can read and latch a page (e.g., row) of data from the memory array 130. The I/O circuitry 144 can be used for bi-directional data communication with host 110 over the interface 156. The read/write circuitry 148 is used to write data to the memory array 130 or read data from the memory array 130. As an example, the circuitry 148 can comprise various drivers, latch circuitry, etc.

Controller 140 decodes signals provided by the host 110. These signals can include chip enable signals, write enable signals, and address latch signals that are used to control operations performed on the memory array 130, including data read, data write, and data erase operations. In various embodiments, the controller 140 is responsible for executing instructions from the host 110. The controller 140 can comprise a state machine, a sequencer, and/or some other type of control circuitry, which may be implemented in the form of hardware, firmware, or software, or any combination of the three.

In various instances, the controller 140 can receive signals provided by the host 110 including signals requesting operations to be performed by a processing unit (PU) 102. For example, the controller 140 can provide a signal requesting that a matrix-vector multiplication operation be performed to the PU 102. The controller 140 can receive the signal from the host 110 and can cause a matrix of data values and a vector of data values to be sensed (e.g., read) from the memory array 130 and provided to the PU 102. As used herein, the PU 102 can include hardware, firmware, and/or software for performing operations using data provided by the memory array 130. For example, the PU 102 can perform multiplication operations in accordance with embodiments of the present disclosure. The PU 102 can multiply a matrix of data values with a vector of data values. As used herein, a data value is a number that can be used to perform operations such as multiplication operations.

In various instances, the PU 102 can utilize I/O lines 103 to receive the matrix of data values and the vector of data values and to output (e.g., provide) a result vector of data values (e.g., the result of the multiplication operations). The result vector of data values can be stored back to the memory array 130 and/or can be provided to the host 110. Utilizing the same I/O lines 103 to read data from the memory array 130, to provide data to the PU 102, and/or to provide data from the PU 102 can allow for the PU 102 to be added to the memory device 120 without substantially adding to the die area of the memory device 120. For example, the PU 102 can be added to the memory device 120 by increasing a die size of the memory device 120 by 1-3% as compared to solutions that do not include the memory device 120. The 1-3% increase in die size is compared to solutions in which the PU 102 is added to the memory device 120 such that the PU 102 does not receive data and/or provide data via the I/O lines 103.

In various examples, the PU 102 can receive columns of data values of a matrix and data values of a vector from the memory array 130 to perform the matrix-vector multiplication operation. The data values of the matrix can be stored in the memory array 130 such that the data values organized in columns can be read as opposed to reading rows of the memory array 130.

In various instances, the controller 140 can cause data values received from the host 110 to be organized and stored in the memory array 130 such that columns of a matrix are stored in memory cells coupled to a same word line. Providing columns of data values to the PU 102 allows the PU 102 to perform operations on the columns of data value such that the results of the matrix-vector multiplication operation are stored in accumulators of MAC units of the PU 102 without performing additional operations to combine the results into a result vector. Providing the result vector of the matrix-vector multiplication operation utilizing the I/O lines 103 and storing the result vector in accumulators of the MAC units of the PU 102 allows for the result vector to be generated and provided to the I/O lines 103 in the same amount of time as is used to read a single column of a memory address (e.g., 256 prefetch) worth of the matrix and/or the vector from the memory array 130.

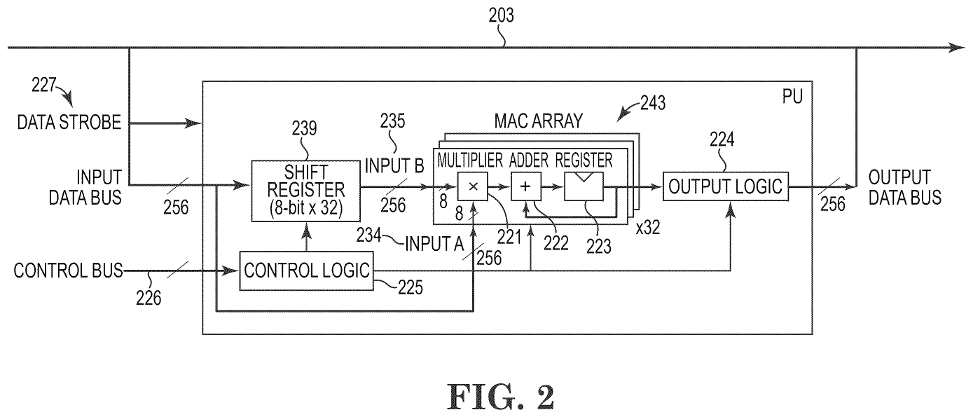

FIG. 2 is a block diagram of a PU 202 in accordance with a number of embodiments of the present disclosure. The PU 202 is coupled to the I/O lines 203. The PU 202 includes the register(s) 239, the MAC units 243, control logic 225, and output logic 224. The PU 202 can receive a data strobe signal 227, a control signal 226, and input signals.

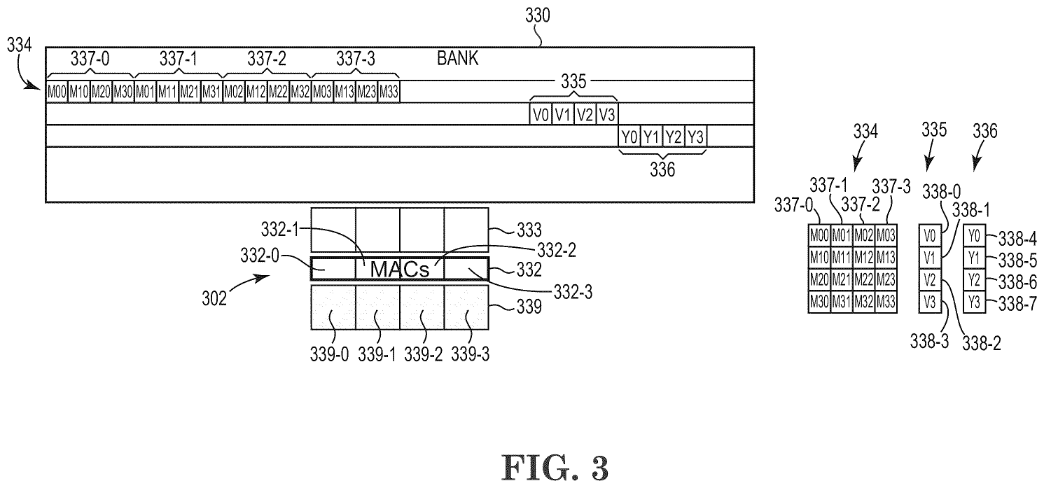

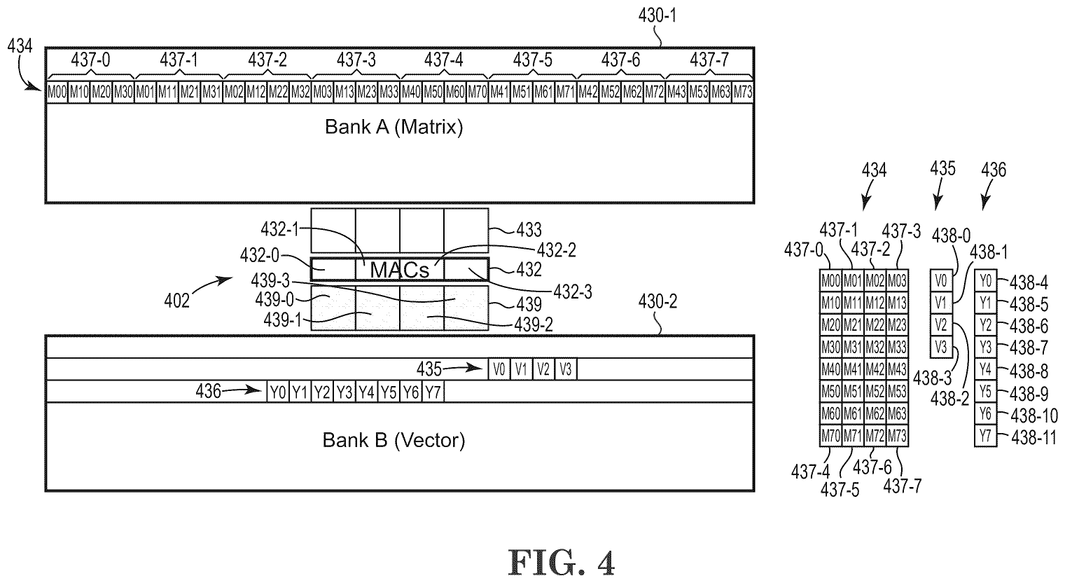

The input signals can provide data values (e.g., data values 234, 234) of a matrix and/or a vector. The data values of the matrix and/or the vector can be provided sequentially. For example, the data values (e.g., data value 235) of a vector can be stored in the register 239. The data values (e.g., data value 234) s of a matrix can be provided directly to the MAC units 243 or can be stored in a different register (not shown) prior to being provided to the MAC units 243. The example of FIG. 2 does not include registers to store the data values of the matrix. The examples of FIGS. 3 and 4 include registers to store the data values of the matrix.

In the example of FIG. 2 a width of the input data bus can be 256-bits. In such an example where the vectors to be operated on include 8 bits, 32 8-bit vectors can be provided in a single 256-bit data chunk. The data values of the matrix can also be provided to the PU in 256-bit chunks. Each of the data values of the vector and the matrix can include 8-bits. The register(s) 239 (Shift Register) can provide each of the data values replicated to fill the 256-bits provided from the registers 239 to the MAC units 243. For example, a first data value (V0) can be replicated thirty-two times to generate 256-bits. Each of the MAC units 243 can receive the same 8-bits (V0) from the 256-bits.

The MAC units 243 can receive the data values from the registers 239 and the data values of the matrix from the I/O lines 203. The MAC units 243 can include multiply circuitry 221, adder circuitry 222, and registers 223. The MAC unit 243 can utilize the multiply circuitry 221, adder circuitry 222, and registers 223 to multiply and accumulate the data values of the vector and the data values of the matrix. The output logic 224 can be controlled to output the output vector. The output vector can be provided to the I/O lines 203.

The data strobe 227 can be utilized to provide timing signals for latching the data values in the registers 239 and for performing the operations of the MAC units 243. The data strobe 227 can also be used to determine when to forward the output vector to the I/O lines 203.

The control signal provided via the control bus 226 can provide the control logic 225 with the information needed to perform a number of operations. For example, the control signal can be utilized to indicate to the registers 239 that the data values should be replicated and/or shifted within the registers 239. The control signal can cause the control logic 225 to indicate to the output logic 224 when to forward the output vector. The data strobe 227 and/or the control signal can be provided by control circuitry of the memory device.

The control signals can be used to load the register 239, forward (e.g., read and/or load) the output vector, and provide data values to the MAC units 243. The control signals can also be used to indicate that the registers 239 should shift data.

FIG. 3 is a block diagram of a bank 330 of memory cells and a PU 302 in accordance with a number of embodiments of the present disclosure. The bank 330 includes memory cells configured to store a matrix 334 of data values, a vector 335 of data values, and a result (e.g., output) vector 336 of data values. Although a single bank 330 is shown as storing the matrix 334, the vector 335, and/or the result vector 336, the matrix 334, the vector 335, and/or the result vector 336 can be stored in different banks. The PU 302 includes matrix registers 333, vector registers 339, and a plurality of MAC units 332 (e.g., MAC units 332-0, 332-1, 332-2, 332-3).

The PU 302 can be configured to perform a matrix-vector multiplication operation. The PU 302 can perform a matrix-vector multiplication operation on the vector 335 utilizing the matrix 334. The matrix-vector multiplication operation can include a plurality of iterations. The results of each iteration can be stored in the MAC units 332. For example, the results of each iteration can be stored in accumulators of the MAC units 332. The results of each iteration of the matrix-vector multiplication operation can be accumulated with previous results of previous iterations of the matrix-vector multiplication operation.

The MAC units 332, after each of the iterations of the matrix-vector multiplication operation, can store and/or provide a result vector 336. The result vector 336 can be an output of the matrix-vector multiplication operation.

As used herein, the matrix 334 can include a plurality of columns 337-0, 337-1, 337-2, 337-3 of data values (e.g., M00, M10, M20, M30, M01, M11, M21, M31, M02, M12, M22, M32, M03, M13, M23, M33). The columns 337-0, 337-1, 337-2, 337-3 of the matrix 334 can be referred to as columns 337.

The vector 335 can include a plurality of data values 338-0, 338-1, 338-2, 338-3. The result vector 336 can include a plurality of data values 338-4 338-5, 338-6, 338-7.

In various instances, the matrix 334 can be stored in the bank 330 in such a way that the columns 337 are provided to the PU 302 together instead of providing the rows of the matrix 334 together to the PU 302. For example, the matrix 334 can be stored in the bank 330 such that a pre-fetch of data read from the bank 330 can include a column of the matrix. The column of the matrix 334 included in the pre-fetch of data read from the bank 330 can be provided to the PU 302. For example, a first pre-fetch can include the column 337-0 of the matrix, a second pre-fetch can include column 337-1, a third pre-fetch can include column 337-2, and a fourth pre-fetch can include the column 337-3. The vector 335 can also be provided as a pre-fetch of data read from the bank 330.

The matrix-vector multiplication operation is defined as Y0=M00×V0+M01×V1+M02×V2+M03×V3, Y1=M10×V0+M11×V1+M12×V2+M13×V3, Y2=M20×V0+M21×V1+M22×V2+M23×V3, and Y3=M30×V0+M31×V1+M32×V2+M33×V3, where the result vector 336 includes the data values 338-4, 338-5, 338-6, 338-7 (e.g., Y0, Y1, Y2, Y3). Each of the data values 338-4, 338-5, 338-6, 338-7 (e.g., Y0, Y1, Y2, Y3) can be calculated by a different MAC unit from the MAC units 332. For example, the data value 338-4 (e.g., Y0) can be calculated by MAC unit 332-0, the data value 338-5 (e.g., Y1) can be calculated by MAC unit 332-1, the data value 338-6 (e.g., Y2) can be calculated by MAC unit 332-2, and the data value 338-7 (e.g., Y3) can be calculated by MAC unit 332-3.

In various examples, the vector 335 can be read from the bank 330 and stored to the vector registers 339. A host can provide a command to the memory device to cause the memory device to read the vector 335. The PU 302 can intercept the vector 335 and can store the vector 335 in the vector registers 339 responsive to receipt of the command from the host. For instance, the data value 338-0 of the vector 335 can be stored in the register 339-0, the data value 338-1 of the vector 335 can be stored in the register 339-1, the data value 338-2 of the vector 335 can be stored in the register 339-2, and the data value 338-3 of the vector 335 can be stored in the register 339-3.

The matrix 334 can be read from the bank 330 and stored to the matrix registers 333. A host can provide a command to the memory device to cause the memory device to read the matrix 334. A different column of the matrix 334 can be stored in the matrix registers 333 for each iteration of the matrix-vector multiplication operation. For instance, the column 337-0 of the matrix 334 can be stored in the matrix registers 333 in a first iteration of the matrix-vector multiplication operation, the column 337-1 of the matrix 334 can be stored in the matrix registers 333 in a second iteration of the matrix-vector multiplication operation, the column 337-2 of the matrix 334 can be stored in the matrix registers 333 in a third iteration of the matrix-vector multiplication operation, and the column 337-3 of the matrix 334 can be stored in the matrix registers 333 in a fourth iteration of the matrix-vector multiplication operation.

In a first iteration of the matrix-vector multiplication operation the column 337-0 and the vector 335 can be stored in the matrix registers 333 and the vector register 339, respectively. The first data value 338-0 of the vector 335 can be stored in the register 339-0. The first data value 338-0 can be provided to each of the MAC units 332. For example, different instances of the first data value 338-0 can be provided to the MAC unit 332-0, the MAC unit 332-1, the MAC unit 332-2, and the MAC unit 332-3. A different data value from the column 337-0 can be provided to each of the MAC units 332. For instance, the data value M00 is provided to the MAC unit 332-0, the data value M10 is provided to the MAC unit 332-1, the data value M20 is provided to the MAC unit 332-2, and the data value M30 is provided to the MAC unit 332-3.

The MAC units 332 can multiply the data values received from the matrix registers 333 and the vector registers 339. For instance, the MAC unit 332-0 can multiply the data value M00 and the data value 338-0, the MAC unit 332-1 can multiply the data value M10 and the data value 338-0, the MAC unit 332-2 can multiply the data value M20 and the data value 338-0, and the MAC unit 332-3 can multiply the data value M30 and the data value 338-0.

The results of the multiplication operations can be stored in accumulators of the MAC units 332. For example, the result of the multiplication operation performed on the data value M00 utilizing the data value 338-0 can be stored in an accumulator of the MAC unit 332-0. The result of the multiplication operation performed on the data value M10 utilizing the data value 338-0 can be stored in an accumulator of the MAC unit 332-1. The result of the multiplication operation performed on the data value M20 utilizing the data value 338-0 can be stored in an accumulator of the MAC unit 332-2. The result of the multiplication operation performed on the data value M30 utilizing the data value 338-0 can be stored in an accumulator of the MAC unit 332-3.

Once the column 337-0 of the matrix 334 has been multiplied by the data value 338-0 of the vector 335, the data values stored in registers 339 can be rotated. For example, the data value 338-1 can be stored in the register 339-0, the data value 338-2 can be stored in the register 339-1, the data value 338-3 can be stored in the register 339-2, and the data value 338-0 can be stored in the register 339-3. The rotation of the data values of the vector in registers 339, the completion of the multiplication operations performed by the MAC units 332, and/or the accumulation of the results of the multiplication operations performed by the MAC units 332 can conclude the first iteration of the matrix-vector multiplication operation.

In a second iteration of the matrix-vector multiplication operation the column 337-1 of data values can be stored in the matrix registers 333. The vector 335 was previously stored and rotated in the prior iteration (e.g., first iteration) of the matrix-vector multiplication operation. The second data value 338-1 of the vector 335 can be stored in the register 339-0. The second data value 338-1 can be provided to each of the MAC units 332. A different data value from the column 337-1 can be provided to each of the MAC units 332. For instance, the data value M01 is provided to the MAC unit 332-0, the data value M11 is provided to the MAC unit 332-1, the data value M21 is provided to the MAC unit 332-2, and the data value M31 is provided to the MAC unit 332-3.

The MAC units 332 can multiply the data values received from the matrix registers 333 and the vector registers 339. For instance, the MAC unit 332-0 can multiply the data value M01 and the data value 338-1, the MAC unit 332-1 can multiply the data value M11 and the data value 338-1, the MAC unit 332-2 can multiply the data value M21 and the data value 338-1, and the MAC unit 332-3 can multiply the data value M31 and the data value 338-1.

The results of the multiplication operations can be accumulated with previous results stored in the accumulators of the MAC units 332. For example, the result of the multiplication operation performed on the data value M01 utilizing the data value 338-1 can be accumulated with a data value stored in the accumulator of the MAC unit 332-0. The result of the multiplication operation performed on the data value M11 utilizing the data value 338-1 can be accumulated with a data value stored in the accumulator of the MAC unit 332-1. The result of the multiplication operation performed on the data value M21 utilizing the data value 338-1 can be accumulated with a data value stored in the accumulator of the MAC unit 332-2. The result of the multiplication operation performed on the data value M31 utilizing the data value 338-1 can be accumulated with a data value stored in the accumulator of the MAC unit 332-3.

Once the column 337-1 of the matrix 334 has been multiplied by the data value 338-1 of the vector 335, the data values stored in registers 339 can be rotated. For example, the data value 338-2 can be stored in the register 339-0, the data value 338-3 can be stored in the register 339-1, the data value 338-0 can be stored in the register 339-2, and the data value 338-1 can be stored in the register 339-3. The rotation of the data values in the registers 339, the completion of the multiplication operations performed by the MAC units 332, and/or the accumulation of the results of the multiplication operations performed by the MAC units 332 can conclude the second iteration of the matrix-vector multiplication operation.

In a third iteration of the matrix-vector multiplication operation the column 337-2 of data values can be stored in the matrix registers 333. The vector 335 was previously stored and rotated in the prior iteration (e.g., second iteration) of the matrix-vector multiplication operation. The third data value 338-2 of the vector 335 can be stored in the register 339-0. The third data value 338-2 can be provided to each of the MAC units 332. A different data value from the column 337-2 can be provided to each of the MAC units 332. For instance, the data value M02 is provided to the MAC unit 332-0, the data value M12 is provided to the MAC unit 332-1, the data value M22 is provided to the MAC unit 332-2, and the data value M32 is provided to the MAC unit 332-3.

The MAC units 332 can multiply the data values received from the matrix registers 333 and the vector registers 339. For instance, the MAC unit 332-0 can multiply the data value M02 and the data value 338-2, the MAC unit 332-1 can multiply the data value M12 and the data value 338-2, the MAC unit 332-2 can multiply the data value M22 and the data value 338-2, and the MAC unit 332-3 can multiply the data value M32 and the data value 338-2.

The results of the multiplication operations can be accumulated with previous results stored in the accumulators of the MAC units 332. For example, the result of the multiplication operation performed on the data value M02 utilizing the data value 338-2 can be accumulated with a data value stored in the accumulator of the MAC unit 332-0. The result of the multiplication operation performed on the data value M12 utilizing the data value 338-2 can be accumulated with a data value stored in the accumulator of the MAC unit 332-1. The result of the multiplication operation performed on the data value M22 utilizing the data value 338-2 can be accumulated with a data value stored in the accumulator of the MAC unit 332-2. The result of the multiplication operation performed on the data value M32 utilizing the data value 338-2 can be accumulated with a data value stored in the accumulator of the MAC unit 332-3.

Once the column 337-2 of the matrix 334 has been multiplied by the data value 338-2 of the vector 335, the data values stored in registers 339 can be rotated. For example, the data value 338-3 can be stored in the register 339-0, the data value 338-0 can be stored in the register 339-1, the data value 338-1 can be stored in the register 339-2, and the data value 338-2 can be stored in the register 339-3. The rotation of the data values in registers 339, the completion of the multiplication operations performed by the MAC units 332, and/or the accumulation of the results of the multiplication operations performed by the MAC units 332 can conclude the third iteration of the matrix-vector multiplication operation.

In a fourth iteration of the matrix-vector multiplication operation the column 337-3 of data values can be stored in the matrix registers 333. The vector 335 was previously stored and rotated in the prior iteration (e.g., third iteration) of the matrix-vector multiplication operation. The fourth data value 338-3 of the vector 335 can be stored in the register 339-0. The fourth data value 338-3 can be provided to each of the MAC units 332. A different data value from the column 337-3 can be provided to each of the MAC units 332. For instance, the data value M03 is provided to the MAC unit 332-0, the data value M13 is provided to the MAC unit 332-1, the data value M23 is provided to the MAC unit 332-2, and the data value M33 is provided to the MAC unit 332-3.

The MAC units 332 can multiply the data values received from the matrix registers 333 and the vector registers 339. For instance, the MAC unit 332-0 can multiply the data value M03 and the data value 338-3, the MAC unit 332-1 can multiply the data value M13 and the data value 338-3, the MAC unit 332-2 can multiply the data value M23 and the data value 338-3, and the MAC unit 332-3 can multiply the data value M33 and the data value 338-3.

The results of the multiplication operations can be accumulated with previous results stored in the accumulators of the MAC units 332. For example, the result of the multiplication operation performed on the data value M03 utilizing the data value 338-3 can be accumulated with a data value stored in the accumulator of the MAC unit 332-0. The result of the multiplication operation performed on the data value M13 utilizing the data value 338-3 can be accumulated with a data value stored in the accumulator of the MAC unit 332-1. The result of the multiplication operation performed on the data value M23 utilizing the data value 338-3 can be accumulated with a data value stored in the accumulator of the MAC unit 332-2. The result of the multiplication operation performed on the data value M33 utilizing the data value 338-3 can be accumulated with a data value stored in the accumulator of the MAC unit 332-3.

Once the column 337-3 of the matrix 334 has been multiplied by the data value 338-3 of the vector 335, the data values stored in registers 339 may or may not be rotated. The completion of the multiplication operations performed by the MAC units 332 and/or the accumulation of the results of the multiplication operations performed by the MAC units 332 can conclude the fourth iteration of the matrix-vector multiplication operation.

The accumulated results stored in the MAC units 332 are the result vector 336. For example, the accumulated result stored in the MAC unit 332-0 is the data value 338-4 (e.g., Y0). The accumulated result stored in the MAC unit 332-1 is the data value 338-5 (e.g., Y1). The accumulated result stored in the MAC unit 332-2 is the data value 338-6 (e.g., Y2). The accumulated result stored in the MAC unit 332-3 is the data value 338-7 (e.g., Y3).

The accumulated results (e.g., Y0, Y1, Y2, Y3) can be read from the MAC units 332 and/or provided to the I/O lines. The accumulated results can be referred to as the result vector 336. The result vector 336 can be provided to the I/O lines of the memory device in a same amount of time utilized to read a single column of a memory address (e.g., 256 prefetch) worth of the matrix 334 and/or the vector 335 from the bank 330.

Although the examples described herein multiply a 4×4 matrix 334 by a 1×4 vector 335 to generate a 1×4 result vector, the embodiments described herein can be implemented on matrices and vectors having different sizes and/or dimensions. FIG. 4 provides an example of performing a matrix-vector multiplication operation on a 4×8 matrix and a 1×4 vector.

FIG. 4 is a block diagram of a plurality of banks 430-1, 430-2 of memory cells and a PU 402 in accordance with a number of embodiments of the present disclosure. The PU 402 includes the matrix registers 433, the vector registers 439, and MAC units 432.

In various instances, a matrix 434 and a vector 435 can be stored in different banks. For example, the matrix 434 is stored in the bank 430-1 (e.g., Bank A) and the vector 435 is stored in the bank 430-2 (e.g., Bank B). The matrix 434 of FIG. 4 is expanded as compared to the matrix 334 of FIG. 3. For example, the matrix 434 may have more rows than the matrix 334. The matrix 434 includes eight rows while the matrix 334 includes four rows. The rows of the matrix 434 may be greater than the quantity of MAC units 432. To accommodate the quantity of data values of the result vector 436, the MAC units 432 may be utilized to generate a portion of the result vector 436 and may be reutilized to generate a different portion of the result vector 436. For example, the MAC units 432 can be used to generate the data values 438-4, 438-5, 438-6, 438-7 in a first quantity of iterations and may be used to generate the data values 438-8, 438-9, 438-10, 438-11 in a second quantity of iterations. The data values 438-4, 438-5, 438-6, 438-7 can be stored in MAC units 432 during a first quantity of iterations while the data values 438-8, 438-9, 438-10, 438-11 are stored in the MAC units 432 in a second quantity of iterations. The data values 438-4, 438-5, 438-6, 438-7 and the data values 438-8, 438-9, 438-10, 438-11 can be stored in the same quantity of registers prior to being provided to the I/O lines as the result vector 436.

As shown in FIG. 4, the matrix 434 can be stored in the bank 430-1 using a column major memory layout. As used herein, a column major memory layout refers to a matrix layout in which columns of a matrix are stored in a bank such that they can be read from the bank together. For example, columns of the matrix 434 are stored in the bank 430-1 such that the columns or portions 437-0, 437-1, 437-2, 437-3, 437-4, 437-5, 437-6, 437-7 of the columns can be read from the bank 430-1 together. The portions 437-0, 437-4 comprise a first column of the matrix 434, the portions 437-1, 437-5 comprise a second column of the matrix 434, the portions 437-2, 437-6 comprise a third column of the matrix 434, and the portions 437-3, 437-7 comprise a fourth column of the matrix 434.

Each of the portions 437-0, 437-1, 437-2, 437-3, 437-4, 437-5, 437-6, 437-7, referred to as portions 437, can comprise a number of data values. For example, each of the portions 437 includes four data values. The portion 437-0 includes the data values M00, M10, M20, and M30. The portion 437-1 includes the data values M01, M11, M21, and M31. The portion 437-2 includes the data values M02, M12, M22, and M32. The portion 437-3 includes the data values M03, M13, M23, and M33. The portion 437-4 includes the data values M40, M50, M60, and M70. The portion 437-5 includes the data values M41, M51, M61, and M71. The portion 437-6 includes the data values M42, M52, M62, and M72. The portion 437-7 includes the data values M43, M53, M63, and M73.

The matrix-vector multiplication operation performed by the PU 402 includes eight iterations. Each iteration of the matrix-vector multiplication operation corresponds to a different one of the portions 437. At each iteration of the matrix-vector multiplication operation a different portion of the matrix can be stored the matrix-registers 433. The vector 435 can be read from the bank 430-2 and stored a single time in the vector registers 439. The data values 438-0, 438-1, 438-2, 438-3 can be rotated after each iteration of the matrix-vector multiplication operation in a manner analogous to that described in the example of FIG. 3.

The matrix-vector multiplication operation for a 4×8 matrix being multiplied by a 1×4 vector in FIG. 4 is defined as Y0=M00×V0+M01×V1+M02×V2+M03×V3, Y1=M10×V0+M11×V1+M12×V2+M13×V3, Y2=M20×V0+M21×V1+M22×V2+M23×V3, Y3=M30×V0+M31×V1+M32×V2+M33×V3, Y4=M40×V0+M41×V1+M42×V2+M43×V3, Y5=M50×V0+M51×V1+M52×V2+M53×V3, Y6=M60×V0+M61×V1+M62×V2+M63×V3, and Y7=M70×V0+M71×V1+M72×V2+M73×V3, where the result vector 436 includes the data values 438-4, 438-5, 438-6, 438-7, 438-8, 438-9, 438-10, 438-11 (e.g., Y0, Y1, Y2, Y3, Y4, Y5, Y6, Y7). Each of Y0, Y1, Y2, Y3, Y4, Y5, Y6, Y7 can be calculated by the MAC units 432. For example, Y0 and Y4 can be calculated by the MAC unit 432-0, Y1 and Y5 can be calculated by the MAC unit 432-1, Y2 and Y6 can be calculated by the MAC unit 432-2, and Y3 and Y7 can be calculated by the MAC unit 432-3. Although specific MAC units 432 are described as calculating particular data values of the result vector 436, any of the MAC units 432 can be used to calculate any of the data values of the result vector 436.

In various examples, the vector 435 can be read from the bank 430-2 and stored to the vector registers 439. A host can provide a command to the memory device to cause the memory device to read the vector 435. The PU 402 can intercept the vector 435 and can store the vector 435 in the vector registers 439 responsive to receipt of the command from the host. For instance, the data value 438-0 of the vector 435 can be stored in the register 439-0, the data value 438-1 of the vector 435 can be stored in the register 439-1, the data value 438-2 of the vector 435 can be stored in the register 439-2, and the data value 438-3 of the vector 435 can be stored in the register 439-3.

The matrix 434 can be read from the bank 430-1 and stored to the matrix registers 433. A host can provide a command to the memory device to cause the memory device to read the matrix 434. A different portion 437 of the columns of the matrix 434 can be stored in the matrix registers 433 for each iteration of the matrix-vector multiplication operation. For instance, the portion 437-0 of the first column of the matrix 434 can be stored in the matrix registers 433 in a first iteration of the matrix-vector multiplication operation, the portion 437-1 of the second column of the matrix 434 can be stored in the matrix registers 433 in a second iteration of the matrix-vector multiplication operation, the portion 437-2 of the third column of the matrix 434 can be stored in the matrix registers 433 in a third iteration of the matrix-vector multiplication operation, and the portion 437-3 of the fourth column of the matrix 434 can be stored in the matrix registers 433 in a fourth iteration of the matrix-vector multiplication operation. The portion 437-4 of the first column of the matrix 434 can be stored in the matrix registers 433 in a fifth iteration of the matrix-vector multiplication operation, the portion 437-5 of the second column of the matrix 434 can be stored in the matrix registers 433 in a sixth iteration of the matrix-vector multiplication operation, the portion 437-6 of the third column of the matrix 434 can be stored in the matrix registers 433 in a seventh iteration of the matrix-vector multiplication operation, the portion 437-7 of the fourth column of the matrix 434 can be stored in the matrix registers 433 in an eighth iteration of the matrix-vector multiplication operation.

In a first iteration of the matrix-vector multiplication operation the portion 437-0 of the first column and the vector 435 can be stored in the matrix registers 433 and the vector register 439, respectively. The first data value 438-0 of the vector 435 can be stored in the register 439-0. The first data value 438-0 can be provided to each of the MAC units 432. For example, different instances of the first data value 438-0 can be provided to the MAC unit 432-0, the MAC unit 432-1, the MAC unit 432-2, and the MAC unit 432-3. A different data value from the portion 437-0 of the first column can be provided to each of the MAC units 432. For instance, the data value M00 is provided to the MAC unit 432-0, the data value M10 is provided to the MAC unit 432-1, the data value M20 is provided to the MAC unit 432-2, and the data value M30 is provided to the MAC unit 432-3.

The MAC units 432 can multiply the data values received from the matrix registers 433 and the vector registers 439. For instance, the MAC unit 432-0 can multiply the data value M00 and the data value 438-0, the MAC unit 432-1 can multiply the data value M10 and the data value 438-0, the MAC unit 432-2 can multiply the data value M20 and the data value 438-0, and the MAC unit 432-3 can multiply the data value M30 and the data value 438-0.

The results of the multiplication operations can be stored in accumulators of the MAC units 432. For example, the result of the multiplication operation performed on the data value M00 utilizing the data value 438-0 can be stored in an accumulator of the MAC unit 432-0. The result of the multiplication operation performed on the data value M10 utilizing the data value 438-0 can be stored in an accumulator of the MAC unit 432-1. The result of the multiplication operation performed on the data value M20 utilizing the data value 438-0 can be stored in an accumulator of the MAC unit 432-2. The result of the multiplication operation performed on the data value M30 utilizing the data value 438-0 can be stored in an accumulator of the MAC unit 432-3.

Once the portion 437-0 of the first column of the matrix 434 has been multiplied by the data value 438-0 of the vector 435, the data values stored in registers 439 can be rotated in a manner analogous to that described in connection with FIG. 3. For example, the data value 438-1 can be stored in the register 439-0. The rotation of the registers 439, the completion of the multiplication operations performed by the MAC units 432, and/or the accumulation of the results of the multiplication operations performed by the MAC units 432 can conclude the first iteration of the matrix-vector multiplication operation.

In a second iteration of the matrix-vector multiplication operation the portion 437-1 of the second column of data values can be stored in the matrix registers 433. The vector 435 was previously stored and rotated in the prior iteration (e.g., first iteration) of the matrix-vector multiplication operation. The second data value 438-1 of the vector 435 can be stored in the register 439-0. The second data value 438-1 can be provided to each of the MAC units 432. A different data value from the portion 437-1 of the second column can be provided to each of the MAC units 432. For instance, the data value M01 is provided to the MAC unit 432-0, the data value M11 is provided to the MAC unit 432-1, the data value M21 is provided to the MAC unit 432-2, and the data value M31 is provided to the MAC unit 432-3.

The MAC units 432 can multiply the data values received from the matrix registers 433 and the vector registers 439. For instance, the MAC unit 432-0 can multiply the data value M01 and the data value 438-1, the MAC unit 432-1 can multiply the data value M11 and the data value 438-1, the MAC unit 432-2 can multiply the data value M21 and the data value 438-1, and the MAC unit 432-3 can multiply the data value M31 and the data value 438-1.

The results of the multiplication operations can be accumulated with previous results stored in the accumulators of the MAC units 432. For example, the result of the multiplication operation performed on the data value M01 utilizing the data value 438-1 can be accumulated with a data value stored in the accumulator of the MAC unit 432-0. The result of the multiplication operation performed on the data value M11 utilizing the data value 438-1 can be accumulated with a data value stored in the accumulator of the MAC unit 432-1. The result of the multiplication operation performed on the data value M21 utilizing the data value 438-1 can be accumulated with a data value stored in the accumulator of the MAC unit 432-2. The result of the multiplication operation performed on the data value M31 utilizing the data value 438-1 can be accumulated with a data value stored in the accumulator of the MAC unit 432-3.

Once the portion 437-1 of the second column of the matrix 434 has been multiplied by the data value 438-1 of the vector 435, the data values stored in registers 439 can be rotated. For example, the data value 438-2 can be stored in the register 439-0. The rotation of the registers 439, the completion of the multiplication operations performed by the MAC units 432, and/or the accumulation of the results of the multiplication operations performed by the MAC units 432 can conclude the second iteration of the matrix-vector multiplication operation.

In a third iteration of the matrix-vector multiplication operation the portion 437-2 of the third column of data values can be stored in the matrix registers 433. The vector 435 was previously stored and rotated in the prior iteration (e.g., second iteration) of the matrix-vector multiplication operation. The third data value 438-2 of the vector 435 can be stored in the register 439-0. The third data value 438-2 can be provided to each of the MAC units 432. A different data value from the portion 437-2 of the third column can be provided to each of the MAC units 432. For instance, the data value M02 is provided to the MAC unit 432-0, the data value M12 is provided to the MAC unit 432-1, the data value M22 is provided to the MAC unit 432-2, and the data value M32 is provided to the MAC unit 432-3.

The MAC units 432 can multiply the data values received from the matrix registers 433 and the vector registers 439. For instance, the MAC unit 432-0 can multiply the data value M02 and the data value 438-2, the MAC unit 432-1 can multiply the data value M12 and the data value 438-2, the MAC unit 432-2 can multiply the data value M22 and the data value 438-2, and the MAC unit 432-3 can multiply the data value M32 and the data value 438-2.

The results of the multiplication operations can be accumulated with previous results stored in the accumulators of the MAC units 432. For example, the result of the multiplication operation performed on the data value M02 utilizing the data value 438-2 can be accumulated with a data value stored in the accumulator of the MAC unit 432-0. The result of the multiplication operation performed on the data value M12 utilizing the data value 438-2 can be accumulated with a data value stored in the accumulator of the MAC unit 432-1. The result of the multiplication operation performed on the data value M22 utilizing the data value 438-2 can be accumulated with a data value stored in the accumulator of the MAC unit 432-2. The result of the multiplication operation performed on the data value M32 utilizing the data value 438-2 can be accumulated with a data value stored in the accumulator of the MAC unit 432-3.

Once the portion 437-2 of the third column of the matrix 434 has been multiplied by the data value 438-2 of the vector 435, the data values stored in registers 439 can be rotated. For example, the data value 438-3 can be stored in the register 439-0. The rotation of the registers 439, the completion of the multiplication operations performed by the MAC units 432, and/or the accumulation of the results of the multiplication operations performed by the MAC units 432 can conclude the third iteration of the matrix-vector multiplication operation.

In a fourth iteration of the matrix-vector multiplication operation the portion 437-3 of the fourth column of data values can be stored in the matrix registers 433. The vector 435 was previously stored and rotated in the prior iteration (e.g., third iteration) of the matrix-vector multiplication operation. The fourth data value 438-3 of the vector 435 can be stored in the register 439-0. The fourth data value 438-3 can be provided to each of the MAC units 432. A different data value from the portion 437-3 of the fourth column can be provided to each of the MAC units 432. For instance, the data value M03 is provided to the MAC unit 432-0, the data value M13 is provided to the MAC unit 432-1, the data value M23 is provided to the MAC unit 432-2, and the data value M33 is provided to the MAC unit 432-3.

The MAC units 432 can multiply the data values received from the matrix registers 433 and the vector registers 439. For instance, the MAC unit 432-0 can multiply the data value M03 and the data value 438-3, the MAC unit 432-1 can multiply the data value M13 and the data value 438-3, the MAC unit 432-2 can multiply the data value M23 and the data value 438-3, and the MAC unit 432-3 can multiply the data value M33 and the data value 438-3.

The results of the multiplication operations can be accumulated with previous results stored in the accumulators of the MAC units 432. For example, the result of the multiplication operation performed on the data value M03 utilizing the data value 438-3 can be accumulated with a data value stored in the accumulator of the MAC unit 432-0. The result of the multiplication operation performed on the data value M13 utilizing the data value 438-3 can be accumulated with a data value stored in the accumulator of the MAC unit 432-1. The result of the multiplication operation performed on the data value M23 utilizing the data value 438-3 can be accumulated with a data value stored in the accumulator of the MAC unit 432-2. The result of the multiplication operation performed on the data value M33 utilizing the data value 438-3 can be accumulated with a data value stored in the accumulator of the MAC unit 432-3.

Once the portion 437-3 of the fourth column of the matrix 434 has been multiplied by the data value 438-3 of the vector 435, the data values stored in registers 439 can be rotated. For example, the data value 438-0 can be stored in the register 439-0. The rotation of the registers 439, the completion of the multiplication operations performed by the MAC units 432, and/or the accumulation of the results of the multiplication operations performed by the MAC units 432 can conclude the fourth iteration of the matrix-vector multiplication operation.

The data values stored in the MAC units 432 can be the data values 438-4, 438-5, 438-6, 438-7 of the result vector 436. The data values 438-4, 438-5, 438-6, 438-7 can be provided to the I/O lines while the data values 438-8, 438-9, 438-10, 438-11 are provided to the I/O lines at a different time. It may be desired to provide the result vector 436 in its entirety at a same time such that the data values 438-4, 438-5, 438-6, 438-7 can be read from the MAC units 432 and stored in different memory (e.g., registers) not shown until the data values 438-8, 438-9, 438-10, 438-11 are generated in the fifth through eighth iteration of the matrix-vector multiplication operation. The MAC units 432 can be reset after the fourth iteration given that the MAC units 432 will be used to generate different data values (e.g., the data values 438-8, 438-9, 438-10, 438-11) of the result vector 436.

In a fifth iteration of the matrix-vector multiplication operation the portion 437-4 of the first column can be stored in the matrix registers 433. The vector 435 was previously stored and rotated in the prior iteration (e.g., fourth iteration) of the matrix-vector multiplication operation. The first data value 438-0 of the vector 435 can be stored in the register 439-0. The first data value 438-0 can be provided to each of the MAC units 432. A different data value from the portion 437-0 of the first column can be provided to each of the MAC units 432. For instance, the data value M40 is provided to the MAC unit 432-0, the data value M50 is provided to the MAC unit 432-1, the data value M60 is provided to the MAC unit 432-2, and the data value M70 is provided to the MAC unit 432-3.

The MAC units 432 can multiply the data values received from the matrix registers 433 and the vector registers 439. For instance, the MAC unit 432-0 can multiply the data value M40 and the data value 438-0, the MAC unit 432-1 can multiply the data value M50 and the data value 438-0, the MAC unit 432-2 can multiply the data value M60 and the data value 438-0, and the MAC unit 432-3 can multiply the data value M70 and the data value 438-0.

The results of the multiplication operations can be stored in accumulators of the MAC units 432. For example, the result of the multiplication operation performed on the data value M40 utilizing the data value 438-0 can be stored in an accumulator of the MAC unit 432-0. The result of the multiplication operation performed on the data value M50 utilizing the data value 438-0 can be stored in an accumulator of the MAC unit 432-1. The result of the multiplication operation performed on the data value M60 utilizing the data value 438-0 can be stored in an accumulator of the MAC unit 432-2. The result of the multiplication operation performed on the data value M70 utilizing the data value 438-0 can be stored in an accumulator of the MAC unit 432-3.

Once the portion 437-4 of the first column of the matrix 434 has been multiplied by the data value 438-0 of the vector 435, the data values stored in registers 439 can be rotated. For example, the data value 438-1 can be stored in the register 439-0. The rotation of the registers 439, the completion of the multiplication operations performed by the MAC units 432, and/or the accumulation of the results of the multiplication operations performed by the MAC units 432 can conclude the fifth iteration of the matrix-vector multiplication operation.

In a sixth iteration of the matrix-vector multiplication operation the portion 437-5 of the second column of data values can be stored in the matrix registers 433. The vector 435 was previously stored and rotated in the prior iteration (e.g., fifth iteration) of the matrix-vector multiplication operation. The second data value 438-1 of the vector 435 can be stored in the register 439-0. The second data value 438-1 can be provided to each of the MAC units 432. A different data value from the portion 437-5 of the second column can be provided to each of the MAC units 432. For instance, the data value M41 is provided to the MAC unit 432-0, the data value M51 is provided to the MAC unit 432-1, the data value M61 is provided to the MAC unit 432-2, and the data value M71 is provided to the MAC unit 432-3.

The MAC units 432 can multiply the data values received from the matrix registers 433 and the vector registers 439. For instance, the MAC unit 432-0 can multiply the data value M41 and the data value 438-1, the MAC unit 432-1 can multiply the data value M51 and the data value 438-1, the MAC unit 432-2 can multiply the data value M61 and the data value 438-1, and the MAC unit 432-3 can multiply the data value M71 and the data value 438-1.

The results of the multiplication operations can be accumulated with previous results stored in the accumulators of the MAC units 432. For example, the result of the multiplication operation performed on the data value M41 utilizing the data value 438-1 can be accumulated with a data value stored in the accumulator of the MAC unit 432-0. The result of the multiplication operation performed on the data value M51 utilizing the data value 438-1 can be accumulated with a data value stored in the accumulator of the MAC unit 432-1. The result of the multiplication operation performed on the data value M61 utilizing the data value 438-1 can be accumulated with a data value stored in the accumulator of the MAC unit 432-2. The result of the multiplication operation performed on the data value M71 utilizing the data value 438-1 can be accumulated with a data value stored in the accumulator of the MAC unit 432-3.

Once the portion 437-5 of the second column of the matrix 434 has been multiplied by the data value 438-1 of the vector 435, the data values stored in registers 439 can be rotated. For example, the data value 438-2 can be stored in the register 439-0. The rotation of the registers 439, the completion of the multiplication operations performed by the MAC units 432, and/or the accumulation of the results of the multiplication operations performed by the MAC units 432 can conclude the sixth iteration of the matrix-vector multiplication operation.

In a seventh iteration of the matrix-vector multiplication operation the portion 437-6 of the third column of data values can be stored in the matrix registers 433. The vector 435 was previously stored and rotated in the prior iteration (e.g., sixth iteration) of the matrix-vector multiplication operation. The third data value 438-2 of the vector 435 can be stored in the register 439-0. The third data value 438-2 can be provided to each of the MAC units 432. A different data value from the portion 437-6 of the third column can be provided to each of the MAC units 432. For instance, the data value M42 is provided to the MAC unit 432-0, the data value M52 is provided to the MAC unit 432-1, the data value M62 is provided to the MAC unit 432-2, and the data value M72 is provided to the MAC unit 432-3.

The MAC units 432 can multiply the data values received from the matrix registers 433 and the vector registers 439. For instance, the MAC unit 432-0 can multiply the data value M42 and the data value 438-2, the MAC unit 432-1 can multiply the data value M52 and the data value 438-2, the MAC unit 432-2 can multiply the data value M62 and the data value 438-2, and the MAC unit 432-3 can multiply the data value M72 and the data value 438-2.

The results of the multiplication operations can be accumulated with previous results stored in the accumulators of the MAC units 432. For example, the result of the multiplication operation performed on the data value M42 utilizing the data value 438-2 can be accumulated with a data value stored in the accumulator of the MAC unit 432-0. The result of the multiplication operation performed on the data value M52 utilizing the data value 438-2 can be accumulated with a data value stored in the accumulator of the MAC unit 432-1. The result of the multiplication operation performed on the data value M62 utilizing the data value 438-2 can be accumulated with a data value stored in the accumulator of the MAC unit 432-2. The result of the multiplication operation performed on the data value M72 utilizing the data value 438-2 can be accumulated with a data value stored in the accumulator of the MAC unit 432-3.

Once the portion 437-6 of the third column of the matrix 434 has been multiplied by the data value 438-2 of the vector 435, the data values stored in registers 439 can be rotated. For example, the data value 438-3 can be stored in the register 439-0. The rotation of the registers 439, the completion of the multiplication operations performed by the MAC units 432, and/or the accumulation of the results of the multiplication operations performed by the MAC units 432 can conclude the seventh iteration of the matrix-vector multiplication operation.

In an eighth iteration of the matrix-vector multiplication operation the portion 437-7 of the fourth column of data values can be stored in the matrix registers 433. The vector 435 was previously stored and rotated in the prior iteration (e.g., seventh iteration) of the matrix-vector multiplication operation. The fourth data value 438-3 of the vector 435 can be stored in the register 439-0. The fourth data value 438-3 can be provided to each of the MAC units 432. A different data value from the portion 437-7 of the fourth column can be provided to each of the MAC units 432. For instance, the data value M43 is provided to the MAC unit 432-0, the data value M53 is provided to the MAC unit 432-1, the data value M63 is provided to the MAC unit 432-2, and the data value M73 is provided to the MAC unit 432-3.

The MAC units 432 can multiply the data values received from the matrix registers 433 and the vector registers 439. For instance, the MAC unit 432-0 can multiply the data value M43 and the data value 438-3, the MAC unit 432-1 can multiply the data value M53 and the data value 438-3, the MAC unit 432-2 can multiply the data value M63 and the data value 438-3, and the MAC unit 432-3 can multiply the data value M73 and the data value 438-3.

The results of the multiplication operations can be accumulated with previous results stored in the accumulators of the MAC units 432. For example, the result of the multiplication operation performed on the data value M43 utilizing the data value 438-3 can be accumulated with a data value stored in the accumulator of the MAC unit 432-0. The result of the multiplication operation performed on the data value M53 utilizing the data value 438-3 can be accumulated with a data value stored in the accumulator of the MAC unit 432-1. The result of the multiplication operation performed on the data value M63 utilizing the data value 438-3 can be accumulated with a data value stored in the accumulator of the MAC unit 432-2. The result of the multiplication operation performed on the data value M73 utilizing the data value 438-3 can be accumulated with a data value stored in the accumulator of the MAC unit 432-3.

Once the portion 437-7 of the fourth column of the matrix 434 has been multiplied by the data value 438-3 of the vector 435, the matrix-vector multiplication operation can be completed. The data values (e.g., data values 438-8, 438-9, 438-10, 438-11) accumulated in the MAC units 432 can be read and stored with the data values 438-4, 438-5, 438-6, 438-7. The data values 438-4, 438-5, 438-6, 438-7, 438-8, 438-9, 438-10, 438-11 once stored together can be read and provided to the I/O lines or can be stored back to one or both of the banks 430-1, 430-2.

Although the examples described in FIG. 4 include a 4×8 matrix, the matrix can be of a different dimension. For example, the matrix 434 can include more than eight rows. The examples described herein can be applied to matrices of any dimension.

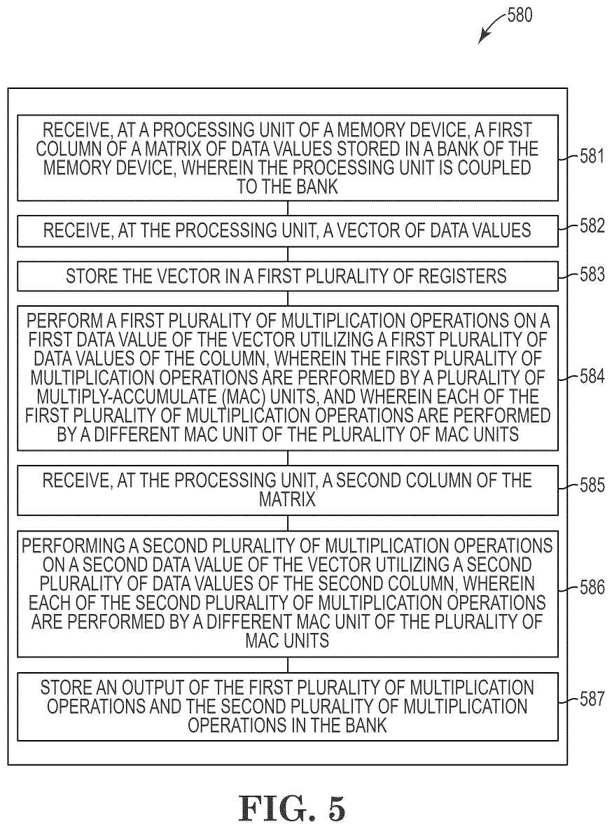

FIG. 5 illustrates an example flow diagram of a method 580 for performing a matrix-vector multiplication operation using a processing unit in memory in accordance with a number of embodiments of the present disclosure. The method can be executed by a memory device of a computing system.

At 581, a PU of a memory device (e.g., memory device 120 of FIG. 1) can receive a first column of a matrix (e.g., matrix 334 or 434 of FIG. 3 or FIG. 4) of data values stored in a bank (e.g., bank 330 or 430-1 of FIG. 3 or FIG. 4) of the memory device, where the processing unit is coupled to the bank of the memory device. At 582, the PU can receive a vector (e.g., vector 335 or 435 of FIG. 3 or FIG. 4) of data values. At 583, the PU can store the vector in a first plurality of registers (e.g., register 339 or 439 of FIG. 3 or FIG. 4) and the first column in a second plurality of registers (e.g., register 333 or 433 of FIG. 3 or FIG. 4). At 584, the PU can perform a first plurality of multiplication operations on a first data value of the vector utilizing a first plurality of data values of the column wherein the first plurality of multiplication operations are performed by a plurality of MAC units and wherein each of the first plurality of multiplication operations are performed by a different MAC unit of the plurality of MAC units.

At 585, the PU can receive a second column of the matrix. At 586, the PU can perform a second plurality of multiplication operations on a second data value of the vector utilizing a second plurality of data values of the second column, wherein each of the second plurality of multiplication operations can be performed by a different MAC unit of the plurality of MAC units. At 587, the PU can store an output of the first plurality of multiplication operations and the second plurality of multiplication operations in the bank.

The PU can receive the vector from the bank of the memory device or a different bank of the memory device (e.g., the vector can be included in the same bank as the matrix, or a different bank than the matrix). In various examples, the PU can receive the vector from a bank of a different memory device.

In various examples, the PU can accumulate the results of the first plurality of multiplication operations and the results of the second plurality of multiplication operations. The results can be accumulated in the MAC units of the PU.

The PU can provide the output of the first plurality of multiplication operations and the second plurality of multiplication operations from the plurality of MAC units to I/O lines of the memory device. The output of the first plurality of multiplication operations and the second plurality of multiplication operations can be provided from the plurality of MAC units to the I/O lines without performing additional operations on the output. For example, the output can be provided without combining the output with different data values. The output can also be provided without performing additional multiplication operations and/or summation operations on the output. The output vector can be provided to the I/O lines in a same amount of time in which a single column of a memory address (e.g., 256 prefetch) worth of the matrix and/or the vector would be provided to the I/O lines.

In various examples, a PU of a memory device can receive a matrix of data values stored in the bank. The PU can receive a vector of data values stored in the bank. The PU can perform a first plurality of multiplication operations on a first data value of the vector utilizing a first plurality of data values of a first column of the matrix, wherein the first plurality of multiplication operations are performed by a plurality of MAC units, and wherein each of the first plurality of multiplication operations are performed by a different MAC unit of the plurality of MAC units. The PU can perform a second plurality of multiplication operations on a second data value of the vector utilizing a second plurality of data values of a second column of the matrix, wherein each of the second plurality of multiplication operations are performed by a different MAC unit of the plurality of MAC units.

The PU can store the first plurality of data values of the first column and the second plurality of data values of the second column in a first plurality of registers and the first data value and the second data value of the vector in a second plurality of registers. The PU can send the first plurality of data values from the first plurality of registers to the plurality of MAC units to perform the first plurality of multiplication operations. The PU can send the first data value from the second plurality of registers to the plurality of MAC units to perform the first plurality of multiplication operations.

The PU can rotate the first data value and the second data value of the vector. The PU can send the second plurality of data values from the first plurality of registers to the plurality of MAC units to perform the second plurality of multiplication operations. The PU can send the second data value from the second plurality of registers to the plurality of MAC units to perform the second plurality of multiplication operations.

In various instances, the bank can store the data values of the matrix in a column major memory layout. The bank can store the data values in the column major memory layout as opposed to the row major memory layout. The bank can provide the data values of the vector to the processing unit in the column major memory layout.

In various examples, the MAC units of the PU can receive a first plurality of data values of a first column of a matrix of data values stored in the first bank, where each MAC unit from the plurality of MAC units receives a different data value from the first plurality of data values of the first column. The MAC units can also receive a first data value of a vector of data values stored in the second bank, where each MAC unit from the plurality of MAC units receives the first data value of the vector.

The MAC units can perform a first plurality of multiplication operations on a first data value of the vector utilizing the first plurality of data values of the first column. Each of the first plurality of multiplication operations can be performed by a different MAC unit of the plurality of MAC units.

The MAC units can receive a second plurality of data values of a second column of the matrix stored in the first bank, where each MAC unit of the plurality of MAC units receives a different data value from the second plurality of data values of the second column. The MAC units can also receive a second data value of the vector, where each MAC unit of the plurality of MAC units receives the second data value of the vector.

The MAC units can perform a second plurality of multiplication operations utilizing the second data value of the vector and the second plurality of data values of the second column. Each of the second plurality of multiplication operations are performed by a different MAC unit of the plurality of MAC units. The MAC units can store an output of the first plurality of multiplication operations and the second plurality of multiplication operations in the second bank.

Each of the MAC units can multiply the first data value with a different data value from the first plurality of data values of the first column and can store a first plurality of results in accumulators of the plurality of MAC units. Each of the plurality of MAC units can multiply the second data value with a different data value from the second plurality of data values of the second column and can add a second plurality of results in the accumulators of the plurality of MAC units.

In various examples, an address sequencer can be implemented in the memory device to generate addresses used to move data from the banks of a memory device to the MAC units. For artificial intelligence (AI) applications, the processing performed by the memory device is matrix multiply-accumulate (MAC) operations. Performing processing in the MAC units can utilize serial data instead of random data. When performing MAC operations in a memory device at the bank level, an entire row of an array can be consumed after it is open, which can reduce the time utilized to perform operations because it takes longer to open and close a row of a memory array than to read data out of the row.

The bank controls for the PU of the memory devices, described herein, however, can allow for normal commands for a memory device and/or memory array. The normal commands can include Activate Row commands, Read commands, and/or Write commands, among other types of commands. The memory device can receive a particular (e.g., special) Read command to redirect bank pre-fetch data (e.g., 256 bits) away from the I/O lines (e.g., DQs) and into the local MAC unit.

After a row of the memory array has been activated, a Read command, along with a column address can be issued every column-to-column timing constraint (tCCD) (5 ns). For instance, there may be 64 Column Addresses for 1 Row, with 16K bits in a row with a 256 bit pre-fetch, and, 64 Read commands are issued after a row activation. Each Read command includes the command and address being supplied external to the chip. Knowing that the data can be read in the same sequential order, circuitry can be added to the memory device that autonomously increments the addresses at the bank so that the addresses do not have to be loaded from off chip. Locally generating addresses saves power and speeds up the read of data into the MAC units as compared to receiving addresses from off chip.

In various instances, in DRAM architecture, reading a matrix of data values out of a memory array may be faster when reading the matrix along the rows rather than reading the matrix along the column. Circuitry can be implemented in a memory device and/or a bank of memory cells that allows for a matrix to be read along the rows or along the columns. For example, the circuitry can be configured to read the matrix along the rows based on a first mode or to read the matrix along the columns based on a second mode. Being able to read the matrix along the row or the columns adds flexibility to the performance of operations using the rows or columns of the matrix.

In various examples, the PU can use the available internal bandwidth of the memory device. For example, a row in each of the banks (e.g., 16 banks) of the memory device can be activated at the same time to provide data to the PU. In previous approaches, a row in each of the banks of the memory device is not activated at the same time. After activation, a read command can be performed on each bank simultaneously. The read command can obtain a corresponding address from the read command address pins. Because each read command obtains an address from the read command address pins, each bank can receive the same column address for a read command. It may be beneficial to initiate read commands at different column addresses in different banks of the memory device. A column address offset register can be implemented in each bank of the memory device to cause incoming addresses to be offset at each bank of the memory device.

In various instances, data (e.g., 256 bit pre-fetch) is available to the MAC unit every tCCD (e.g., every 5 ns). A MAC unit can be implemented for each bank of a memory device. The MAC unit can process 256 bits as input. However, the MAC unit can perform a number of operations faster than 5 ns. The die size of a memory device can be reduced by reducing the MAC unit to handle 128 bits of data instead of 256 bits of data. The 256 bits of data that the bank provides every 5 ns can be provided to the MAC unit in two 128 bit portions. Each 128 bit portion can be processed in 25 ns (serialized through the MAC). Reducing the size of the MAC unit can reduce the cost of the memory device.

In a number of examples, having the MAC units at each bank of a memory device allows the data in the MAC units to be read from the bank or written to the bank. However, a write to the bank may not be needed. Artificial intelligence (AI) algorithms may utilize multiply/accumulate operations. The accumulation data is stored in the MAC unit and utilizes little space. The ability to write to the bank from the MAC unit can be removed. Removing the ability to write to the bank from the MAC unit saves die size and simplifies operations. Removing the ability to write to the bank from the MAC unit also provides the benefit of making data concurrency a non-issue. If the data in the MAC units needs to be stored, the CPU (external controller) can read the data from the MAC unit and then store the data to the bank.

In previous approaches, a standard memory array (e.g., bank) allows 1 data path (e.g., pre-fetch data path 256 bits) out for each tCCD (e.g., 5 ns). This is a physical (e.g., architectural) choice to meet DRAM data sheet specifications. Increasing the number of bits per pre-fetch out of the bank would not be of benefit to a standard memory array (e.g., DRAM). However, with a bank local processing unit (e.g., PU/MAC unit as described herein), increasing this data path would allow a higher bandwidth. For instance, such a local processing unit can double this path with a small die size increase. The number of DSA's (data sense amps) can be doubled and the Global Data Lines (GIO's) can be segmented to accommodate increasing the data path between the bank and the MAC unit.

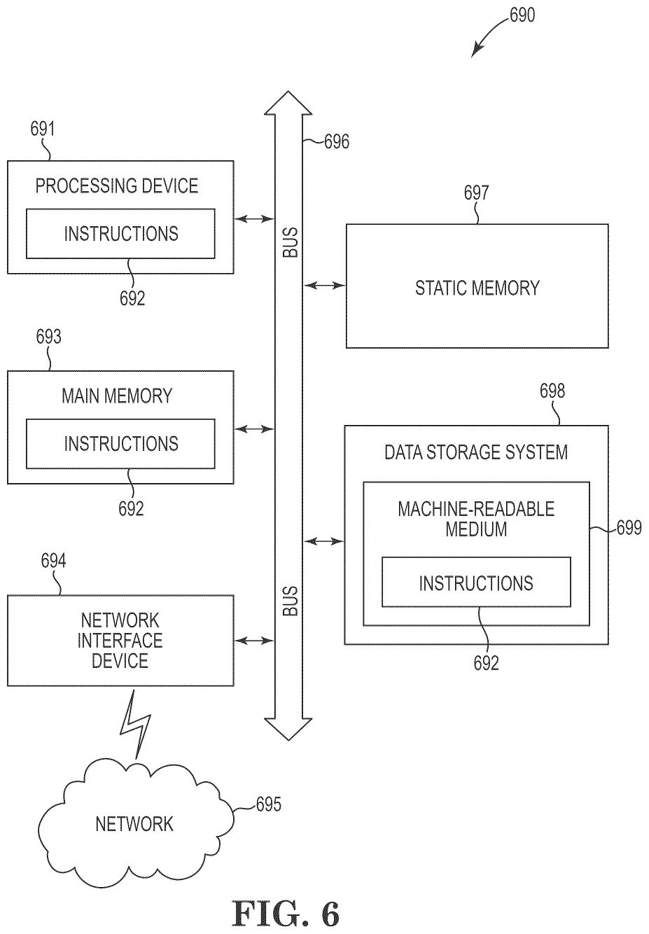

FIG. 6 illustrates an example machine of a computer system 690 within which a set of instructions, for causing the machine to perform any one or more of the methodologies discussed herein, can be executed. In some embodiments, the computer system 690 can correspond to a host system (e.g., the system 110 of FIG. 1) that includes, is coupled to, or utilizes a memory system (e.g., the memory device 120 of FIG. 1) or can be used to perform the operations of the PU (e.g., the PU 102 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 690 includes a processing device 691, a main memory 693 (e.g., read-only memory (ROM), flash memory, dynamic random access memory (DRAM) such as synchronous DRAM (SDRAM) or Rambus DRAM (RDRAM), etc.), a static memory 697 (e.g., flash memory, static random access memory (SRAM), etc.), and a data storage system 698, which communicate with each other via a bus 696.

Processing device 691 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 691 can also be one or more special-purpose processing devices such as an application specific integrated circuit (ASIC), a field programmable gate array (FPGA), a digital signal processor (DSP), network processor, or the like. The processing device 691 is configured to execute instructions 692 for performing the operations and steps discussed herein. The computer system 690 can further include a network interface device 694 to communicate over the network 695.

The data storage system 698 can include a machine-readable storage medium 699 (also known as a computer-readable medium) on which is stored one or more sets of instructions 692 or software embodying any one or more of the methodologies or functions described herein. The instructions 692 can also reside, completely or at least partially, within the main memory 693 and/or within the processing device 691 during execution thereof by the computer system 690, the main memory 693 and the processing device 691 also constituting machine-readable storage media.

In one embodiment, the instructions 692 include instructions to implement functionality corresponding to the controller 140 of FIG. 1. While the machine-readable storage medium 699 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Although specific embodiments have been illustrated and described herein, those of ordinary skill in the art will appreciate that an arrangement calculated to achieve the same results can be substituted for the specific embodiments shown. This disclosure is intended to cover adaptations or variations of various embodiments of the present disclosure. It is to be understood that the above description has been made in an illustrative fashion, and not a restrictive one. Combinations of the above embodiments, and other embodiments not specifically described herein will be apparent to those of skill in the art upon reviewing the above description. The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus, comprising:
a bank of memory cells;
a processing unit coupled to the bank of memory cells and configured to:
receive a matrix of data values stored in the bank;
receive a vector of data values stored in the bank;
perform a first plurality of multiplication operations on a first data value of the vector utilizing a first plurality of data values of a first column of the matrix,
wherein the first plurality of multiplication operations are performed by a plurality of multiply-accumulate (MAC) units, and
wherein each of the first plurality of multiplication operations are performed by a different MAC unit of the plurality of MAC units; and
perform a second plurality of multiplication operations on a second data value of the vector utilizing a second plurality of data values of a second column of the matrix,
wherein each of the second plurality of multiplication operations are performed by a different MAC unit of the plurality of MAC units.

2. The apparatus of claim 1, wherein the processing unit is further configured to store the first plurality of data values of the first column and the second plurality of data values of the second column in a first plurality of registers and the first data value and the second data value of the vector in a first plurality of registers.

3. The apparatus of claim 2, wherein the processing unit is further configured to send the first plurality of data values from the first plurality of registers to the plurality of MAC units to perform the first plurality of multiplication operations.

4. The apparatus of claim 2, wherein the processing unit is further configured to send the first data value from the second plurality of registers to the plurality of MAC units to perform the first plurality of multiplication operations.

5. The apparatus of claim 4, wherein the processing unit is further configured to rotate the first data value and the second data value of the vector.

6. The apparatus of claim 5, wherein the processing unit is further configured to send the second plurality of data values from the first plurality of registers to the plurality of MAC units to perform the second plurality of multiplication operations.

7. The apparatus of claim 4, wherein the processing unit is further configured to send the second data value from the second plurality of registers to the plurality of MAC units to perform the second plurality of multiplication operations.

8. The apparatus of claim 1, wherein the bank is configured to store the data values of the matrix in a column major memory layout.

9. The apparatus of claim 8, wherein the bank is configured to provide the data values of the vector to the processing unit in the column major memory layout.

10. A method comprising:
receiving, at a processing unit of a memory device, a first column of a matrix of data values stored in a bank of the memory device, wherein the processing unit is coupled to the bank;
receiving, at the processing unit, a vector of data values;
storing the vector in a first plurality of registers;
performing a first plurality of multiplication operations on a first data value of the vector utilizing a first plurality of data values of the column,
wherein the first plurality of multiplication operations are performed by a plurality of multiply-accumulate (MAC) units, and
wherein each of the first plurality of multiplication operations are performed by a different MAC unit of the plurality of MAC units; and
receiving, at the processing unit, a second column of the matrix;
performing a second plurality of multiplication operations on a second data value of the vector utilizing a second plurality of data values of the second column,
wherein each of the second plurality of multiplication operations are performed by a different MAC unit of the plurality of MAC units; and
storing an output of the first plurality of multiplication operations and the second plurality of multiplication operations in the bank.

11. The method of claim 10, further comprising receiving the vector from the bank of the memory device.

12. The method of claim 10, further comprising receiving the vector from a different bank of the memory device.

13. The method of claim 10, further comprising accumulating results of the first plurality of multiplication operations and results of the second plurality of multiplication operations in the plurality of MAC units.

14. The method of claim 10, further comprising providing the output of the first plurality of multiplication operations and the second plurality of multiplication operations from the plurality of MAC units to input/output (I/O) lines of the memory device.

15. The method of claim 14, further comprising providing the output of the first plurality of multiplication operations and the second plurality of multiplication operations from the plurality of MAC units to the I/O lines without performing additional operations on the output.

16. The method of claim 15, wherein providing the output of the first plurality of multiplication operations and the second plurality of multiplication operations from the plurality of MAC units to the I/O lines without performing additional operations on the output comprises providing the output without combining the output with different data values.

17. The method of claim 10, further comprising providing the output vector to the I/O lines in a same amount of time in which a single column of a memory address worth of the matrix would be provided to the I/O lines.

18. An apparatus, comprising:
a first bank of memory cells;
a second bank of memory cells;
a processing unit, comprising a plurality of multiply-accumulate (MAC) units, coupled to the first bank and the second bank;
wherein the plurality of MAC units are configured to:
receive a first plurality of data values of a first column of a matrix of data values stored in the first bank, wherein each MAC unit from the plurality of MAC units receives a different data value from the first plurality of data values of the first column;
receive a first data value of a vector of data values stored in the second bank, wherein each MAC unit from the plurality of MAC units receives the first data value of the vector;
perform a first plurality of multiplication operations on a first data value of the vector utilizing the first plurality of data values of the first column,
wherein each of the first plurality of multiplication operations are performed by a different MAC unit of the plurality of MAC units;
receive a second plurality of data values of a second column of the matrix stored in the first bank, wherein each MAC unit of the plurality of MAC units receives a different data value from the second plurality of data values of the second column;
receive a second data value of the vector, wherein each MAC unit of the plurality of MAC units receives the second data value of the vector;
perform a second plurality of multiplication operations utilizing the second data value of the vector and the second plurality of data values of the second column,
wherein each of the second plurality of multiplication operations are performed by a different MAC unit of the plurality of MAC units; and
store an output of the first plurality of multiplication operations and the second plurality of multiplication operations in the second bank.

19. The apparatus of claim 18, wherein each of the plurality of MAC units multiplies the first data value with a different data value from the first plurality of data values of the first column and stores a first plurality of results in accumulators of the plurality of MAC units.

20. The apparatus of claim 18, wherein each of the plurality of MAC units multiplies the second data value with a different data value from the second plurality of data values of the second column and adds a second plurality of results in the accumulators of the plurality of MAC units.
